(19) United States
(12) Patent Application Publication
(10) Pub. No.: US 2020/0290491 A1
(43) Pub. Date: Sep. 17, 2020

(54) Motor Vehicle Seat Protective Film, Film Web Comprising Motor Vehicle Seat Protective Films, Method for Producing a Film Web and Motor Vehicle Seat Assembly

(71) Applicant: Horn & Bauer GmbH & Co. KG, Schwalmstadt (DE)

(72) Inventor: Thomas Mohr, Neustadt-Momberg (DE)

(21) Appl. No.: 16/814,201

(22) Filed: Mar. 10, 2020

(30) Foreign Application Priority Data
Mar. 11, 2019 (DE) 20 2019 101 357.5

(51) Int. Cl. B60N 2/60

(52) U.S. Cl. CPC B60N 2/6018

(57) ABSTRACT

The present invention relates to a motor vehicle seat protective film designated for being imposed on a motor vehicle seat. The motor vehicle seat protective film is manufactured from a rectangular plastic film. The motor vehicle seat protective film comprises a folding in the upper end region separating a front sheet from a rear sheet. The front sheet and the rear sheet are welded to each other by weldings. The lateral distance of the weldings corresponds to the dimension of a headrest of the motor vehicle seat.

### CROSS REFERENCE TO RELATED APPLICATIONS

This application claims priority to co-pending German Utility Model DE 20 2019 101 357.5 filed on Mar. 11, 2019 and entitled “Kraftfahrzeugsitz-Schutzfolie and Folienbahn mit Kraftfahrzeugsitz-Schutzfolien”.

### FIELD OF THE INVENTION

The present invention relates to a motor vehicle seat protective film and a film web comprising a plurality of motor vehicle seat protective films of this type. Furthermore, the invention relates to a motor vehicle seat assembly comprising a motor vehicle seat and a motor vehicle seat protective film protecting the motor vehicle seat and a method for producing a film web.

Motor vehicle seat protective films are imposed on or pulled on motor vehicle seats in order to avoid contamination or soiling of the motor vehicle seat, in particular by a driver, by a passenger, by a service technician, by other persons or by contaminations from the environment. Motor vehicle seat protective films are e.g. used in automobile workshops during an inspection or repair of a motorized vehicle. Furthermore, motor vehicle seat protective films are used for avoiding a contamination of the motor vehicle seat at the manufacturer of the motor vehicle seat and when the motor vehicle seat is supplied to the car factory or in the car factory itself. Also during the assembly of the motor vehicle a plurality of assembly operators subsequently contact the motor vehicle seats. At the end, the assembled motor vehicle has to be driven from the manufacturing line and has to be driven onto a lorry, railway wagon or ship and driven from the same and, in the end, handled again a plurality of times at a vehicle dealership before the vehicle and the motor vehicle seat can finally be turned over to the purchaser in the best clean state. From the time when the motor vehicle seat is produced at the suppliers facility to the time when the motor vehicle is handed over to the purchaser, the motor vehicle's seat in some cases comes into contact with service technicians and other people some 30 to 35 times. Accordingly, there are many opportunities for the vehicle seat to become soiled which can be avoided with a motor vehicle seat protective film.

### BACKGROUND OF THE INVENTION

U.S. Pat. No. 4,676,376 A discloses a motor vehicle seat protective film which is shown in FIG. 1 in a state imposed on a motor vehicle seat embodied as a seat bench. The motor vehicle seat protective film 1 comprises a plastic film 2. The width of the plastic film 2 is the same as the width of the motor vehicle seat 3 in the region of a seat cushion 4 and a backrest 5. In the upper end region of the backrest 5 the plastic film 2 comprises a folding 6 which divides the plastic film 2 into a front sheet 7 and a rear sheet 8. The sections of the front sheet 7 and the rear sheet 8 adjacent to the folding 6 form a front sheet pocket region 9 and a rear sheet pocket region 10 which limit a pocket 11. The pocket 11 is imposed on the upper end region of the backrest 5. In order to allow a lateral closure of the pocket 11, the plastic film 2 comprises lateral tongues 12, 13 in the front sheet pocket region 9 and the rear sheet pocket region 10. The tongues 12, 13 encompass the lateral regions of the backrest 5 and the ends of the tongues 12, 13 are welded to each other by a welding 14. The pocket 11 serves for fixing the motor vehicle seat protective film 1 to a backrest 5 and so to the motor vehicle seat 3. Remote from the front sheet pocket region 9 the front sheet 7 comprises a front sheet covering region 15. The front sheet covering region 15 covers the sides of the backrest 5 and the seat cushion 4 facing towards the driver or passenger in a protective way. For the shown embodiment the front sheet covering region 15 has a length such that the front sheet covering region 15 extends beyond the front edge of the seat cushion 4, the front sheet covering region 15 hangs down from the front edge and so the front sheet covering region 15 also protects the front side of the seat cushion 4. In order to improve the fixation of the motor vehicle seat protective film 1 at the motor vehicle seat 3 (additional to a centering and fixing by the accommodation of the backrest 5 in the pocket 11 of the motor vehicle seat protective film 1) U.S. Pat. No. 4,676,376 A proposes that the motor vehicle seat protective film 1 is manufactured from a plastic film 2 comprising two layers. The layer which in use faces the motor vehicle seat 3 has a friction and adhesion being higher than that of the layer facing away from the motor vehicle seat 3 and interacting with the person. The different design of the friction and adhesion of the two layers leads to the result that during a movement of a person sitting on the motor vehicle seat 3 with the motor vehicle seat protective film 1 arranged thereon (due to the lower friction and adhesion in the contact area between the person and the layer of the motor vehicle seat protective film 1 facing towards the person) there is a relative movement between the person and the motor vehicle seat protective film 1 whereas the motor vehicle seat protective film 1 contacts and adheres to the motor vehicle seat 3 without a relative movement or only a small extend of the relative movement. Accordingly, in the areas which are to be protected the motor vehicle seat protective film 1 is secured by the friction or adhering effect against undesired relative movements (which might lead to a deterioration of the protective effect strived for). U.S. Pat. No. 4,676,376 A proposes that the layer of the plastic film 2 facing away from the motor vehicle seat 3 (which in the following will also be denoted as “first outer layer”) is made of a high density polyethylene (in the following “HDPE”), whereas the layer facing towards the vehicle seat 3 (which in the following will also be denoted as “second outer layer”) is made of a low-density polyethylene (in the following “LDPE”), in particular a linear low-density polyethylene (in the following “LLDPE”).

Here, the LLDPE might be an LLDPE with or without additive, optional additives being diatomaceous earth or sand. The first outer layer might be regular HDPE or HDPE with a high or medium molecular weight. It is proposed that the thickness of the plastic film is at least 0.3 mil. The first outer layer should have a coefficient of friction of 0.2 or less whereas the second outer layer should have a coefficient of friction of at least 0.5. It is also possible that the second outer layer is charged statically in order to strengthen the adhering effect of the same. The layer thickness of the first outer layer is approximately 10-20% of the thickness of the plastic film. For storing a plurality of motor vehicle seat protective films 1 the motor vehicle seat protective film 1 can be folded twice in the front sheet covering region. A number of motor vehicle seat protective films 1 folded in this way can then be stockpiled and stored in a cardboard box and then successively be taken from an opening of the cardboard box according to the needs.

On the website www.slipngrip.com the applicant of U.S. Pat. No. 4,676,376 A offers a protective film made of a plastic film having two layers with different frictions and adhering effects. Here, the plastic film has a rectangular shape and does not comprise the tongues described above. For this embodiment, the plastic film is (relative to the width of the vehicle seat) wider than in the U.S. Pat. No. 4,676,376 A and so wider than the width of the backrest. Accordingly, lateral side regions of the front sheet and the rear sheet extend along side regions of the upper end region of the backrest, and the edges of the front sheet and the rear sheet are directly welded to each other for forming the pocket. The motor vehicle seat protective film according to the website www.slipngrip.com is (differing from the motor vehicle seat protective film of U.S. Pat. No. 4,676,376 A) designated for a motor vehicle seat comprising a headrest. In order to be able to fix the motor vehicle seat protective film in the upper end region of the backrest to the motor vehicle seat, the pocket here comprises an increased depth so that the pocket extends from the headrest over the cap between the headrest and the backrest up to the upper end region of the backrest.

DE 36 01 390 C1 (corresponding to GB patent application GB 2 185 391 B) discloses a set of protective films designated for covering vehicle parts when performing repair works. The set of protective films comprises a motor vehicle seat protective film and additional protective film parts as e.g. a steering wheel cover, a footwell cover and other protective films designated for providing a protection. Here, the motor vehicle seat protective film comprises one or two pockets and the motor vehicle protective film might not have or might have perforations in the end region of an upper pocket for allowing the passage of a headrest. A storage coil might comprise a film web wherein (transverse to the feeding direction of the film web during the manufacturing and transverse to the winding direction of the storage coil) motor vehicle seat protective films are linked to each other which can then be separated from each other by perforations. For the formation of at least one pocket the film web is folded in the region of a lateral edge (when seen in the feeding direction of the film web). For providing a lateral limitation of the pocket the folded film section is welded to the unfolded film section. A footwell cover and a cover for the steering wheel can loosely be inserted into the pocket.

DE 195 36 062 C1 (corresponding to U.S. Pat. No. 5,709,431 A) discloses a motor vehicle seat protective film which for a first embodiment comprises only one upper pocket. The width of the upper pocket corresponds to the constant width of the motor vehicle seat protective film and so to the width of the motor vehicle seat. The upper pocket comprises a first film piece which forms the front sheet of the motor vehicle seat protective film and a second film piece which forms a rear sheet in the region of the upper pocket. For the formation of an upper pocket being open in downward direction the film pieces are welded to each other by lateral weldings and an upper welding. During the production the motor vehicle seat protective film has an orientation transverse to the feeding direction. The lateral weldings can be located in the region of the upper pocket which contacts the headrest of the motor vehicle seat. The upper pocket is designated for accommodating the upper end region of the backrest and a headrest. A plurality of motor vehicle seat protective films are provided being linked to a film web from which the motor vehicle seat protective film can then be separated from each other in the region of perforations. For another embodiment, by another film piece also a lower pocket is provided at the motor vehicle seat protective film. The protective film might be manufactured from a co-extruded film material comprising two or three layers. The outer layers might have differing coefficients of friction and a middle layer might have an increased tear strength.

DE 28 51 649 A1 (corresponding to GB patent application GB 2 011 254 A) discloses a motor vehicle seat protective film made of a transparent plastic material as polyethylene. The motor vehicle seat protective film consists of a plastic film which is folded laterally in inner direction from a front sheet in the region of the lateral edges via a first folding, folded laterally in outer direction closely adjacent to the first folding by a second folding and again folded laterally in inner direction in the region of a third folding which is arranged above the first folding so that back sheet parts are formed. Between the first folding and the third folding the protective film comprises wedge parts of excess material. The lateral inner end regions of the two rear sheet parts adjoin each other establishing a continuous gap, the gap having an orientation in longitudinal direction. In the upper end region and in the lower end region the two rear sheet parts are welded to the front sheet by lateral weldings. The rear sheet parts (together with the associated film sections of the front sheet) form lateral pockets. It is possible to insert the backrest and a seat cushion in lateral direction into the lateral pockets. The lateral pockets laterally enclose the motor vehicle seat.

DE 196 45 999 C1 (corresponding to U.S. Pat. No. 5,911,476 A) discloses a motor vehicle seat protective film comprising four sheets arranged one above the other. The four sheets form a seat pocket having a width corresponding to the width of the seat cushion and form a pocket having a width corresponding to the width of the backrest.

DE 33 41 541 A1 also discloses a motor vehicle seat protective film wherein a film web (which comprises foldings extending in longitudinal direction of the motor vehicle seat protective film) is pre-folded such that the film web forms a front sheet and an upper rear sheet part and a lower rear sheet part. By weldings of the rear sheet parts to the front sheet an upper pocket designated for the backrest and a lower pocket designated for the seat cushion are formed.

DE 10 2013 105 728 A1 discloses the layer design, layer thicknesses and composition of the layers of a multi-layered film which comprises an adhesive layer which can be thermically activated. A multi-layered film of this type is designated for a laminate for manufacturing furniture and/or floor linings.

DE 92 04 236 U1 discloses a motor vehicle seat protective film comprising an upper pocket designated for being imposed on a backrest and a lower pocket being designated for being imposed on a seat cushion. The motor vehicle seat protective film might comprise a fixing and engaging strap. By the fixing and engaging strap it is possible to additionally fix the motor vehicle seat protective film in a gap between the backrest and the seat cushion. Preferably, the backside of the front sheet facing towards the motor vehicle seat has a design for being secured against slippage. For this purpose the rear side might have a higher coefficient of friction than the front sheet. In the upper end region the upper pocket might comprise passage openings for the rods of a headrest. Accordingly, here the headrest is arranged outside from the upper pocket and not protected by the motor vehicle seat protective film.

DE 20 2012 001 042 U1 discloses a seat cushion cover for a motor vehicle seat for covering the headrest, the front side of the backrest, the upper side of the seat cushion and the lateral surfaces of the backrest and the seat cushion. The seat cover comprises an upper pocket having a width corresponding to the constant width of the seat cover so that the width of the upper pocket is larger than the width of the backrest. Accordingly, it is possible to impose the seat cushion cover both on a motor vehicle seat which comprises a headrest as well as on a motor vehicle seat which does not comprise a headrest. The seat cushion cover has a width of approximately 75 cm to 90 cm and comprises a length of 100 cm to 150 cm. The depth of the upper pocket is in the range of 25 to 50 cm. It is also possible that a seat cushion cover of this type is intended for covering a plurality of seats or a seat bench. In this case a wider film and a wider upper pocket has to be provided. The side of the seat cushion cover facing towards the user should be smooth and slippy whereas the rear side should have strong adhering properties in order to provide an anti-slip property of the seat cushion cover relative to the motor vehicle seat. The film might comprise two layers which might consist of different types of polyethylene. For the layer which forms the front side facing towards the user a type of polyethylene of high density (e.g. HDPE) can be used in order to provide the desired smooth property. For the layer forming the rear side facing towards the motor vehicle seat it is proposed to use a layer comprising a polyethylene of low density (in particular LDPE or LLDPE) in order to provide the desired high coefficient of friction and good adhering properties. A setting of the adhering properties might be provided by use of a suitable additive and/or an electro-static charging. The layers might have different thicknesses. Between the aforementioned layers a third layer might be arranged which might consist of recycled polyethylene.

Embodiments known from the publications EP 0 564 872 B1 (corresponding to CA patent application CA 2 092 487 A1) and EP 2 008 866 A2 generally correspond to the embodiment known from DE 92 04 236 U1.

### SUMMARY OF THE INVENTION

The invention proposes a motor vehicle seat protective film which preferably consists of only one plastic film and weldings produced at the plastic film and which (without the weldings in the unfolded state) has a rectangular shape.

For one embodiment of the invention a motor vehicle seat protective film is proposed which when providing
the protective effect of the motor vehicle seat protective film and
the required fixation of the motor vehicle seat protective film to a motor vehicle seat against slipping (in particular due to a movement of the person sitting thereon)

leads to
reduced manufacturing costs,
a reduced material usage,
a mono-material disposal,
a space-saving and/or workable storage and/or
an appealing optical design of the motor vehicle seat protective film on a motor vehicle seat.

For one embodiment of the invention the plastic film comprises a folding by which the plastic film is divided into a front sheet and a back sheet. The front sheet comprises two different functional portions, namely a front sheet upper end region and a front sheet covering region. The front sheet covering region serves for covering at least a large portion of the motor vehicle seat (namely of the backrest and of the seat cushion) on the side of the motor vehicle seat facing towards the person sitting on the motor vehicle seat. The front sheet upper end region serves for forming a pocket and for covering the front side of the headrest. The rear sheet comprises a rear sheet upper end region. The front sheet upper end region and the rear sheet upper end region limit a pocket. This pocket can be imposed on a part of a motor vehicle seat. In this way a position and/or orientation of the motor vehicle seat protective film relative to the motor vehicle seat can be set and in some cases in this way also a fixation of the motor vehicle seat protective film at the motor vehicle seat can be provided. It is possible that the pocket comprises a certain oversize to the dimension of the part of the motor vehicle seat or the pocket might closely enclose this part. In the case that the plastic film comprises an elasticity, it is even possible that the pocket in a non-elastically stretched state has a smaller circumferential extension than the circumferential extension of the part of the motor vehicle seat. Accordingly, for imposing it is required to elastically widen the pocket and then due to the elasticity of the pocket the part of the motor vehicle seat is tightly enclosed by the pre-tension or residual tension of the plastic film.

According to the invention the part of the motor vehicle seat on which the motor vehicle seat protective film is imposed is not the backrest as being the case in U.S. Pat. No. 4,676,376 A. Instead, the pocket is designed and designated for being imposed on a headrest of the motor vehicle seat (and preferably only on the headrest because the pocket is too small or too narrow or tight for being imposed on the upper end region of the backrest).

The inventive proposal in particular bases on the finding that for the design of a pocket for being imposed on the backrest according to U.S. Pat. No. 4,676,376 A it is required that the plastic film comprises lateral tongues that are designated for extending along the lateral regions of the backrest. However, due to these tongues it is not possible to use a rectangular plastic film for the motor vehicle seat protective film. Instead, it is required to use a T-shaped plastic film wherein the side legs of the T form the tongues, or it is required to weld the tongues to a rectangular plastic film. Accordingly, the embodiment of U.S. Pat. No. 4,676,376 A require an excessive use of material and/or leads to increased manufacturing costs.

If instead an embodiment according to the website www.slipngrip.com is used, the motor vehicle seat protective film bases on a rectangular plastic film. However, the width of the plastic film has to be larger than the width of the backrest for allowing that the plastic film also covers the lateral side regions of the backrest and in order to allow a welding of the overlapping lateral edges to the pocket. Accordingly, the plastic film has a width being larger than required so that there is an excess usage of material.

Additionally, the embodiment shown on the website www.slipngrip.com also requires that the motor vehicle seat protective film extends beyond the lateral edges of the backrest and the seat cushion. Accordingly, the motor vehicle seat protective film laterally hangs down from the motor vehicle seat which in some cases is considered as a non-appealing optical design.

Due to legal requirements motor vehicle seats comprise a headrest. A motor vehicle seat protective film should also provide the protective effect for such a motor vehicle seat having a headrest if the headrest has partially or even completely been extracted. As a consequence, for the known motor vehicle seat protective film according to U.S. Pat. No. 4,676,376 A and according to the website www.slipngrip.com for allowing its imposing on the backrest the depth of the pocket has to be chosen to be sufficiently large such that also for the maximally extended headrest the pocket still extends down to the upper end region of the backrest. Accordingly, for the known motor vehicle seat protective films the required depth T of the pocket corresponds to the sum of
the coverage of the backrest by the pocket,
the heights of the headrest and
the distance K of the headrest from the backrest in the maximally extended state.

However, the provision of a large depth T is required for the known motor vehicle seat protective films both on the front side in the region of the front sheet as well as on the rear side in the region of the rear sheet. Accordingly, it is required to provide material sections of the plastic film with a longitudinal extension of 2×K for forming the pocket.

For one embodiment of the invention these problems are (at least partially) avoided by designing and designating the pocket (instead of for its imposing on the backrest) for the imposing on the headrest of the motor vehicle seat. Accordingly, it is possible to reduce the usage of material and/or the manufacturing effort. In this way, a motor vehicle seat protective film is provided which leads to an appealing design when applied to the motor vehicle seat. For establishing the pocket the front sheet upper end region and the rear sheet upper end region are directly welded to each other by weldings. The lateral distance of the weldings is smaller than the width of the plastic film. In the extreme case, the width of the used plastic film and of the motor vehicle seat protective film is as large as the width of the motor vehicle seat or might also be chosen to be smaller than the width of the motor vehicle seat (without this necessarily being the case).

Due to the fact that according to the invention it is only the headrest which extends into the pocket, the material which is to be provided for forming the pocket does not depend on the position of the headrest. Instead, the distance K between the headrest and the upper end region of the backrest can be bridged by the front sheet covering region. As a consequence, the material for covering the distance between the headrest and the backrest has to be provided only once in the region of the front sheet covering region. Accordingly, it is also possible to reduce the longitudinal extension of the plastic film when compared to the plastic film for a motor vehicle seat protective film according to the prior art (in particular with a reduction by at least the distance K).

For the design of the weldings there are a lot of options. It is e.g. possible that the weldings are embodied as (straight, parallel or inclined or curved) point-weldings or line-weldings. The weldings might also be inclined so that these (similar to a kind of funnel or cone) ease the imposing of the motor vehicle seat protective film on a headrest. The distance A of the weldings in lateral direction is arbitrary as long as the distance A is smaller than the width B of the plastic film. Preferably, the lateral distance A of the weldings is less than 95%, less than 90%, less than 85%, less than 80%, less than 75%, less than 70%, less than 65%, less than 60%, less than 55%, less than 50%, less than 45%, less than 40% or less than 35% of the width B of the plastic film.

Preferably, in the front sheet upper end region the weldings separate or distinguish a front sheet pocket region from front sheet side regions arranged laterally from the front sheet pocket region (and so arranged laterally in the side region). Cumulatively or alternatively, in the rear sheet upper end region the weldings separate or distinguish a rear sheet pocket region from rear sheet side regions arranged laterally from the rear sheet pocket region (and arranged laterally in the side region). In this case, the pocket is exclusively limited by the front sheet pocket region, the rear sheet pocket region and the weldings when seen in circumferential direction.

However, for an alternative design it is also possible that the front sheet side regions and/or the rear sheet side regions are at least partially cut away. Here, in the case of completely cutting the front sheet side regions and the rear sheet side regions away the motor vehicle seat protective film has a stepped shape in the region of the upper edge where the stepped shape can be adapted to the stepped shape of the transition region between the headrest and the backrest.

It is possible that in the upper end region the front sheet covering region comprises lateral corner regions. In the case that the rear sheet side regions and the front sheet side regions have been cut away as explained above, the lateral corner regions are free so that these corner regions are only fixed to the motor vehicle seat by adhering to the backrest. There might be the danger that the lateral corner regions fold down at the instance of a contact with the person so that the protective effect of the motor vehicle seat protective film would be removed in the region of the upper edge of the backrest. For one embodiment of the invention the corner regions are connected via the front sheet side regions to a welding, the front sheet pocket region and/or via the folding to the rear sheet pocket region and/or a rear sheet side region. Accordingly, the folding down of the lateral corner regions mentioned above is impeded so that the protective effect of the motor vehicle seat protective film and the optical appearance of the same when applied to the motor vehicle seat is improved.

Generally, the motor vehicle seat protective film might be manufactured from a plastic film
of any composition and/or
of any layer configuration and/or
of any coloring and/or
of any printing and/or
comprising any additional components.

It is also possible that the plastic film consists of a plurality of plastic film portions differing with respect to the above criteria and linked to each other.

Preferably, the plastic film has a thickness being smaller than 100 μm (preferably smaller than 90 μm, smaller than 80 μm, smaller than 70 μm, smaller than 60 μm, smaller than 50 μm, smaller than 40 μm, smaller than 30 μm, smaller than 25 μm, smaller than 20 μm or smaller than 15 μm). By the choice of a plastic film having a small thickness it is possible to further reduce the usage of material and for this choice it is also possible to store a plurality of motor vehicle seat protective films with a reduced storage volume.

For one proposal of the invention the plastic film comprises at least two layers (e.g. two layers or three layers). Here, when using more than two layers an inner layer might e.g. serve for providing a coloring in combination with transparent outer layers, might serve for providing an elasticity or strength or tearing strength of the motor vehicle seat protective film and the like.

Furthermore, one embodiment of the invention proposes that a first outer layer of the plastic film comprises a lower friction and/or adhering effect than a second outer layer of the plastic film. The first outer layer of the plastic film then provides the contact area for the person, so that the first outer layer is arranged on the side facing away from the motor vehicle seat. Instead, the second outer layer of the plastic film faces towards the motor vehicle seat and due to its higher friction and/or adhering effect provides that the plastic film does not move or moves with a reduced extend when a person moves on the motor vehicle seat. For the first and second outer layers (and also additional layers) any materials can be used as mentioned above which might optionally also comprise any additive. Within the frame of the invention the adhering effect and/or friction can be influenced in particular by the choice of the coefficient of friction of the outer side of the layer, an electro-static charging of a layer and/or the choice of the material and optional additives to the same.

For one proposal of the invention the first outer layer comprises HDPE (or consists of HDPE) whereas the second outer layer comprises LLDPE (or consists of LLDPE).

The invention also proposes an embodiment of the motor vehicle seat protective film wherein the second outer layer (that might comprise LLDPE) comprises chalk with a percentage by weight of 3 to 20%. By the addition of chalk it is possible to achieve the intended friction and/or adhering effect. Nevertheless, it is at the time provided that it is possible to easily open the pocket before imposing the motor vehicle seat protective film on the motor vehicle seat. The desired characteristics can then be set by the choice of the percentage by weight of the addition of chalk.

The plastic film can be manufactured in any way. Preferably, the plastic film (e.g. provided as a film web or a closed or slitted tube) is manufactured in a continuous extrusion process and then cut to length. This can be done with any extrusional direction of the plastic film. For one proposal of the invention the plastic film is manufactured with a direction of extrusion (and in some cases also with a feeding or supply direction in the subsequent process of further processing) having an orientation transverse to the longitudinal extension of the motor vehicle seat protective film.

In particular for a space saving storage of the motor vehicle seat protective film (e.g. stock-piled in a storage reservoir as a cardboard box or wound to a coil) it might be advantageous that the motor vehicle seat protective film comprises an additional folding in the front sheet covering region. Preferably, the additional folding is arranged in the middle of the longitudinal extension of the front sheet covering region. This design might have the consequence that in the stored state the motor vehicle seat protective film has a longitudinal extension which equals the sum of the half of the longitudinal extension of the front sheet covering region and the depth of the pocket. However, it is also possible that a plurality of additional foldings are provided (in the region of the front sheet covering region and/or in the region of the front sheet upper end region and rear sheet upper end region) in order to further reduce the dimensions of the motor vehicle seat protective film in the storage state.

For a particular embodiment the motor vehicle seat protective foil (which considers the manufacturing demands) the motor vehicle seat protective film is embodied as a tube section. Here, the tube section comprises a slit. The slit separates a lower edge of the plastic film from an upper edge of the plastic film. Here, the lower edge of the plastic film is the lower edge of the front sheet covering region whereas the upper edge of the plastic film limits the entry opening of the pocket. In the storage state the tube section comprises flattenings which form the two aforementioned foldings. The tube section ends of the tube section form the lateral edges of the plastic film (and so the lateral edges of the front sheet covering region and the lateral edges of the front sheet side regions and of the rear sheet side regions).

Preferably, the depth of the pocket of the motor vehicle seat protective film which is designated for being imposed on the headrest is smaller than 400 mm, in particular smaller than 350 mm or smaller than 300 mm. Accordingly, the longitudinal extension of the front sheet upper end region and of the rear sheet upper end region is also that small which in the end leads to the result that the usage of material for producing the motor vehicle seat protective film is reduced.

One embodiment of the invention also relates to the reduction of the usage of material of the motor vehicle seat protective film. Here, the longitudinal extension and the width of the film from which the motor vehicle seat protective film is produced are determined when the film without weldings is completely unfolded. For one embodiment of the invention the longitudinal extension in this state is less than 25% (preferably less than 20%, preferably less than 17%, preferably less than 15% or preferably even less than 13%) larger than the length of the motor vehicle seat protective film in the state ready for use, so the state with the folding and the weldings. Accordingly, the longitudinal extension of the film is smaller than the longitudinal extension of the films known from the prior art which leads to the reduction of the usage of material. In contrast thereto the width of the film corresponds to the width of the motor vehicle seat protective film in the state ready for use so that it is possible to take benefit of the complete width of the film.

For one proposal of the invention the width of the motor vehicle seat protective film is smaller than 900 mm (in particular smaller than 850 mm, smaller than 800 mm, smaller than 750 mm, smaller than 700 mm, smaller than 650 mm or even smaller than 600 mm).

Here, the width of the pocket might be smaller than 650 mm (in particular smaller than 600 mm, smaller than 550 mm or even smaller than 530 mm).

The invention also proposes a film web wherein a plurality of motor vehicle seat protective films as described before are linked to each other. Preferably, the motor vehicle seat protective films are connected to each other by perforations. It is possible that the film web is manufactured in a continuous or semi-continuous manufacturing process as e. g. an extrusion process. Here, it is possible that in the extrusion process a tube is manufactured having a plurality of tube sections as described above and linked to each other by perforations. In this case, the slits can be produced by feeding the tube along a blade or any other stationary severing element. However, it is also possible that a plane film web is produced which is then flattened and folded. Then, at any point of the manufacturing process the weldings can be generated by any welding process.

Furthermore, the invention proposes a method for producing a film web comprising a plurality of motor vehicle seat protective film of the aforementioned type. In this method at first a tube section is produced, in particular in a continuous extrusion process. The tube section is then provided with flattenings that form the foldings of the later motor vehicle seat protective film. Subsequently, a slit is generated in the tube section, e.g. by a severing blade along which the continuously produced and feeded tube section is moved. The slit of the tube section separates the lower edge of the motor vehicle seat protective film from the upper edge of the same. Before or after the generation of the slit the weldings are produced. The weldings are produced with a distance from each other being smaller than the width of the tube section. Furthermore, cuts or incisions are produced (preferably after the aforementioned method steps) which form the lateral edges of the plastic film of the motor vehicle seat protective film. For an alternative embodiment it is possible that perforations are generated which (after the brakeage of the same by the user) form the lateral edges of the plastic film of the motor vehicle seat protective film.

The invention also proposes a motor vehicle seat assembly. The motor vehicle seat assembly comprises a motor vehicle seat and a motor vehicle seat protective film which protects the motor vehicle seat and has a design as described above. In the motor vehicle seat assembly the pocket of the motor vehicle seat protective film is imposed on the headrest of the motor vehicle seat which might be the case with a close or tight accommodation of the headrest under use of the elasticity of the headrest and/or the elasticity of the material of the pocket. However, it is also possible that the pocket is plastically deformed so that the pocket closely accommodates or houses the headrest. A plastic deformation of the pocket might also allow the specific adaptation of the size of the pocket to the specific headrest according to the needs. It is also possible that the pocket is dimensioned such that the pocket can be pulled easily and with some play over the headrest. To start with, by means of the pocket all sides of the headrest (except the underside) are protected. On the other hand, the accommodation of the headrest in the pocket provides a first securing effect of the motor vehicle seat protective film against displacements by slippage. The front sheet covering region of the motor vehicle seat protective film is loosely lying on the motor vehicle seat and covers the seat cushion and the backrest of the motor vehicle seat which might be the case for a part of the width of the seat cushion and the backrest, the whole width of the seat cushion and the backrest or with some oversize when compared to the width of the seat cushion and/or the backrest. Accordingly, it is also possible that the front sheet covering region also laterally covers the seat cushion and protects the same. According to the invention the seat cushion and the backrest are not accommodated in an additional pocket which reduces the assembly effort, reduces the usage of material and reduces the manufacturing costs of the motor vehicle seat protective film. According to one embodiment of the invention the motor vehicle seat protective film is exclusively secured by the aforementioned first securing, namely the accommodation of the headrest of the motor vehicle seat in the pocket of the motor vehicle seat protective film and by a second securing effect against slippage. However, the second securing effect is not provided by an additional pocket, by straps for tying, insertion elements for a gap between the seat cushion and the backrest and the like as required for the additional securing according to the prior art. Instead, the second securing is provided by the friction of the front sheet covering region with the seat cushion and/or the backrest of the motor vehicle seat. Alternatively or accumulatively the second securing effect might be provided by an adhering effect of the front sheet covering region with the seat cushion and/or the backrest. Here, the adhering effect might purposefully be achieved or increased by statically charging the motor vehicle seat protective film or the front sheet covering region or by treating the same with a corona treatment. It has surprisingly been noted that a securing effect provided by means of
the pocket for the headrest on the one hand side and
the friction of the front sheet covering region with the seat cushion and/or the backrest and/or the adhering effect on the other hand side

is sufficient for securing against slippage. Here, preferably the friction of the front sheet covering region is higher on the side facing towards the seat cushion and the backrest than the friction on the other side which interacts with the person sitting on the motor vehicle seat equipped with the motor vehicle seat protective film. In this case movements of the person result in a slipping movement between the person and the front side of the motor vehicle seat protective film facing towards the person. Instead, the motor vehicle seat protective film is secured by the two aforementioned securing effects against a slippage on the motor vehicle seat.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

Many variations and modifications may be made to the preferred embodiments of the invention without departing substantially from the spirit and principles of the invention. All such modifications and variations are intended to be included herein within the scope of the present invention, as defined by the following claims.

### BRIEF DESCRIPTION OF THE DRAWINGS

In the following, the invention is further explained and described with respect to preferred exemplary embodiments illustrated in the drawings.

FIG. 1 shows a motor vehicle seat with a motor vehicle seat protective film according to the prior art (cp. U.S. Pat. No. 4,676,376 A) in a three-dimensional view.

FIG. 2 shows a motor vehicle seat protective film in a front view and in a flattened state.

FIG. 3 shows the motor vehicle seat protective film of FIG. 2 in a side view (where here the weldings are not shown).

FIG. 4 shows the motor vehicle seat protective foil of FIGS. 2 and 3 in a representation according to FIG. 2 with optional dimensions.

FIG. 5 shows a motor vehicle seat protective film corresponding to FIGS. 2 to 4 in a state without an additional folding in a rear view.

FIG. 6 shows the motor vehicle seat protective film of FIG. 5 in a folded state for a storage in a rear view.

FIG. 7 shows the motor vehicle seat protective film of FIG. 6 in a side view (where here the weldings are not shown).

FIG. 8 shows a film web with a plurality of motor vehicle seat protective films linked to each other by perforations.

FIG. 9 in a schematic three-dimensional view shows a motor vehicle seat protective film applied upon a motor vehicle seat.

FIG. 10 in a schematic side view shows the motor vehicle seat protective foil applied to the motor vehicle seat.

### DETAILED DESCRIPTION

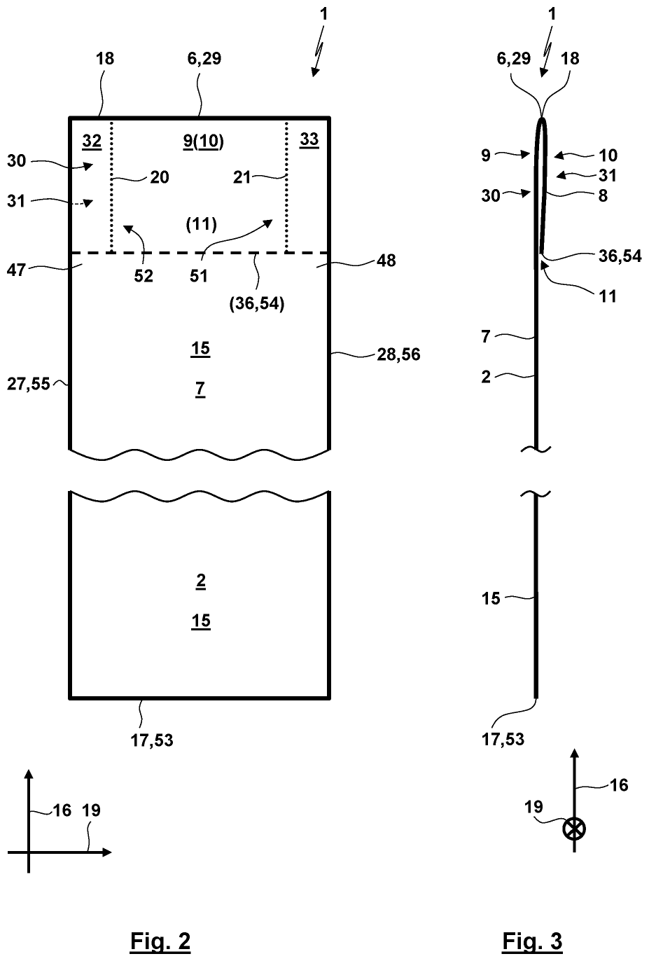

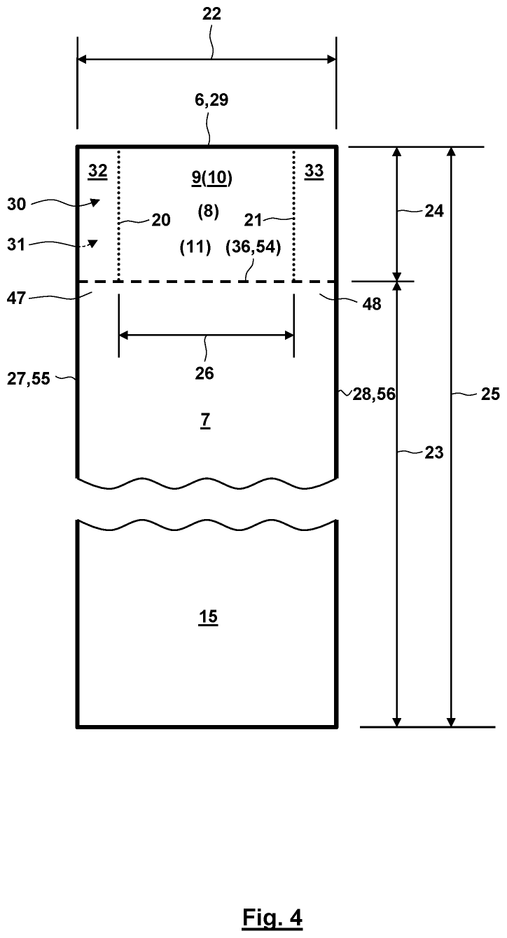

In the present description a longitudinal direction of the motor vehicle seat protective film 1 denotes a main extensional direction of the motor vehicle seat protective film 1 which for an orientation of the motor vehicle seat protective film according to FIG. 2 extends from a lower edge 17 of the front sheet covering region 15 to an upper edge 18 of the motor vehicle seat protective film 1 (which is provided by the folding 6) and is oriented in vertical direction in FIG. 2. Instead, a lateral direction 19 or transverse direction denotes a direction having an orientation vertical to the longitudinal direction 16 and having an orientation in horizontal direction in FIG. 2. The lateral direction 19 is oriented in the direction of the shorter extension of the motor vehicle seat protective film 1. It is e.g. possible that the lower edge 17 and the upper edge 18 extend in lateral direction 19, whereas the lateral edges of the motor vehicle seat protective film 1 extend in longitudinal direction 16. If the motor vehicle seat protective film 1 is applied to a motor vehicle seat 3, the motor vehicle seat protective film 1 is angled corresponding to the contour of the motor vehicle seat 3 so that then in the lower portion of the front sheet covering region 15 the longitudinal direction 16 of the motor vehicle seat protective film 1 has an orientation approximately in longitudinal direction of the motor vehicle or of the seat cushion 4 whereas the longitudinal direction 16 of the motor vehicle seat protective film 1 in the upper portion of the front sheet covering region 15 and in the region of the pocket 11 has an orientation approximately in the direction of the vehicle jaw axis or the vertical axis of the backrest 5.

The motor vehicle seat protective film 1 consists of a plastic film 2 with weldings 20, 21. Preferably, the weldings 20 are produced only by generation of heat and by a direct connection of the front sheet 7 to the rear sheet 8 without the application of additional material. The plastic film 2 comprises a rectangular geometry. The width B of the rectangular geometry is denoted with the reference numeral 21 in FIG. 4. The length L of the rectangular plastic film 2 results from the sum of the length 23 of the front sheet covering region 15 and the double of the depth T of the pocket 11 being denoted with reference numeral 24 in FIG. 4. In the unfolded state the motor vehicle seat protective film 1 comprises a length 25 resulting from the sum of the length 23 and the depth T 24. A lateral welding distance A of the weldings 20, 21 is denoted with reference numeral 26 in FIG. 4. For the shown embodiment the weldings 20, 21 have the same distance from the lateral edges 27, 28 of the motor vehicle seat protective film 1 (without this necessarily being the case).

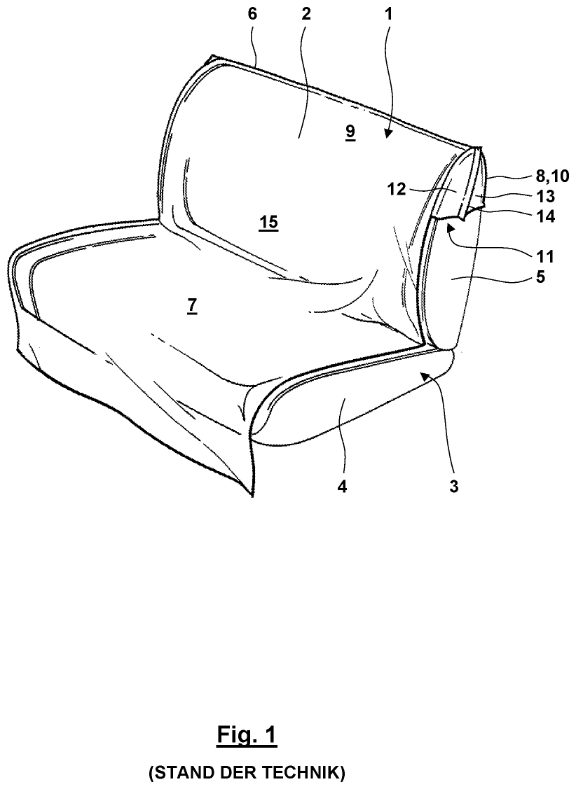

A folding (which is here formed by a flattening 29) divides the plastic film 2 into a front sheet 7 and a rear sheet 8. The length 25 equals a front sheet length of the front sheet 7. The portions of the front sheet 7 and of the rear sheet 8 adjacent to the folding 6 form a front sheet upper end region 20 and a rear sheet upper end region 31. The depth 24 equals a rear sheet length of the rear sheet 8, a front sheet upper end region length of the front sheet upper end region 20 and a rear sheet upper end region length of the rear sheet upper end region 31. The front sheet upper end region 30 and the rear sheet upper end region 31 form a front sheet pocket region 9 respectively a rear sheet pocket region 10 and front sheet side regions 32, 33 or rear sheet side regions 34, 35 arranged remote therefrom and separated by the weldings 20, 21. The pocket 11 is limited in circumferential direction only by the front sheet pocket region 9 and the rear sheet pocket region 10 (and the weldings 20, 21). The pocket 11 is limited in the upper end region by the folding 6 so that the folding 6 forms a kind of “bottom” of the pocket 11. Tongues, as these are used in a motor vehicle seat protective film according to the prior art (cp. FIG. 1) are not present in the inventive motor vehicle seat protective film 1 (at least for forming the pocket 11). The edge 36 of the rear sheet and of the rear sheet upper end region 31 facing away from the folding 6 limits the entry opening of the pocket 11.

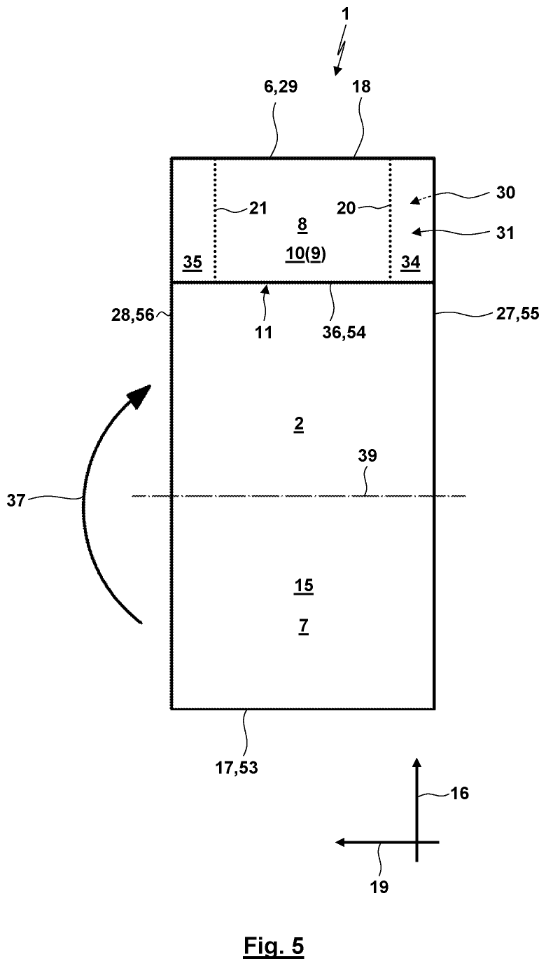

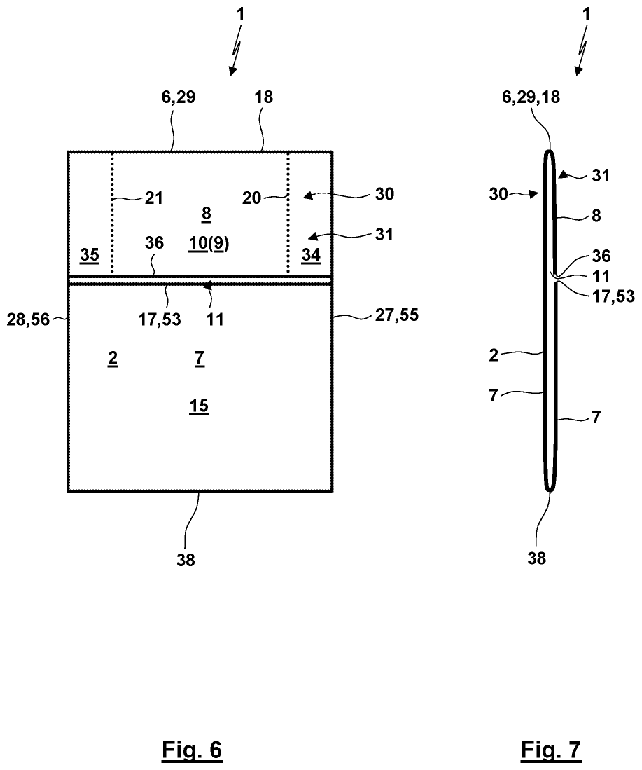

It is possible that by means of an additional folding process 37 an additional folding 38 is provided along a folding line 39 arranged in the middle of the front sheet covering region 15 (cp. the transition from FIG. 5 to FIG. 6/7).

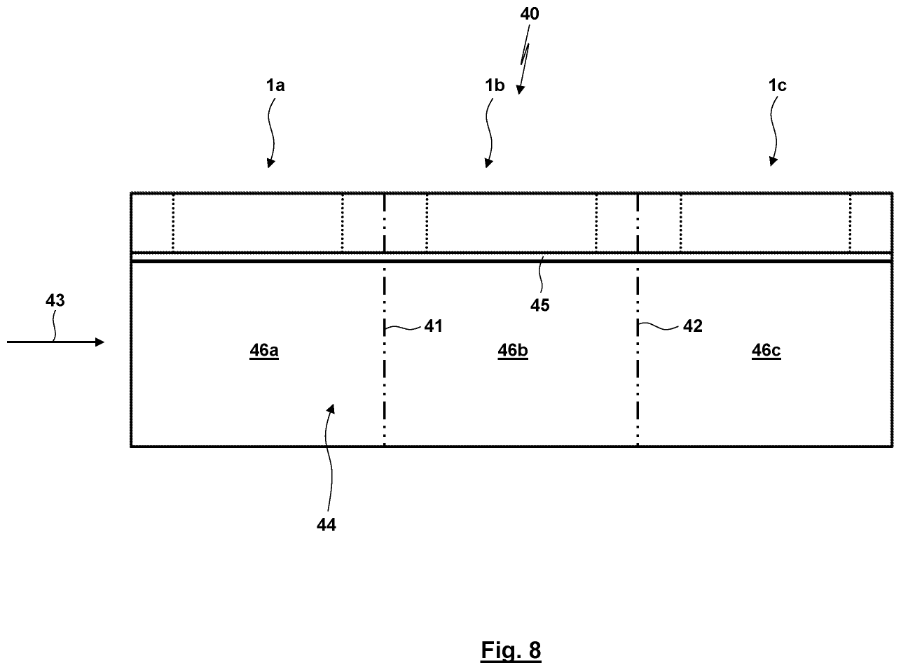

FIG. 8 shows a film web 40 wherein a plurality of motor vehicle seat protective films 1a, 1b, 1c, . . . are linked to each other by perforations 41. By separating the perforations 41, 42 the user is able to separate single motor vehicle seat protective films 1a, 1b, 1c, . . . from the film web 40 for the upcoming use. In FIG. 8 a direction of extrusion 43 is indicated which corresponds to the lateral direction 19 of the single motor vehicle seat protective films 1a, 1b, 1c, . . . . The direction of extrusion 43 is a direction of extrusion in a continuous extrusion process, a feeding direction of the film web 40 during the manufacturing process and/or during the processing of the same and/or a direction in which the film web 40 is wound to a coil.

A possible manufacturing process of the film web 40 according to FIG. 8 is as follows: In a continuous extrusion process a (film-) tube 44 is manufactured in a direction of extrusion 43. By means of a blade or a different severing means a continuous slit 45 is produced in the tube 44. The slit 45 is limited by the edges 17, 36 of the motor vehicle seat protective films 1a, 1 b, 1c, . . . . Furthermore, transverse to the direction of extrusion 43 on the one hand weldings 20, 21 of the respective motor vehicle seat protective films 1a, 1 b, 1c, . . . as well as the perforations 41, 42 are produced. Subsequently, the film web 40 produced in this way is wound to a coil. The single motor vehicle seat protective films 1a, 1b, 1c, . . . each form tube sections 46a, 46b, 46c, . . . in the tube 40 comprising the slit 45.

In the following possible dimensions of the motor vehicle seat protective film 1 (which are not intended for limiting the invention) are listed.

| | Length 23 | Depth 24 | Width 22 | Distance 26 |
|---|---|---|---|---|
| Embodiment 1 | 1350 mm | 200 mm | 850 mm | 420 mm |
| Embodiment 2 | 1500 mm | 250 mm | 900 mm | 500 mm |
| Embodiment 3 | 1600 mm | 300 mm | 950 mm | 600 mm |
| Embodiment 4 | 1550 mm | 200 mm | 850 mm | 510 mm |

In order to mention only one additional example, the depth 24, the width 22 and the lateral welding distance 26 might vary from the above dimensions by ±20%, ±15%, ±10% or ±5% whereas for these variations or also the dimensions given above for the embodiments 1 to 3 the length 23 might differ from the lengths given above.

It is also possible that the length 23, the depth 24, the width 22 and/or the lateral welding distance 26 differ from the above dimensions by a maximum of ±20%, ±15%, ±10% or ±5%.

Preferably, the pocket 11 is dimensioned such that the double of the lateral welding distance 26
is oversized when compared to the circumference of the headrest 49 or
exactly equals the circumference of the headrest 49 or
is undersized when compared to the circumference of the headrest 49 by an extend which can be compensated by the elasticity of the plastic film 2.

The depth 24 of the pocket 11 is then chosen corresponding to the extension H of the headrest 49 in heights direction or slightly larger than the same (e.g. by a maximum of 5%, by a maximum of 10% or by a maximum of 20% larger than the same). However, it is also possible that the depth 24 of the pocket 11 is less than 60%, less than 70%, less than 80% or less than 90% or more than 110%, more than 120%, more than 130% or more than 140% of the extension of the headrest in heights direction. It is e.g. possible that the depth 24 of the pocket 11 is in the range of 150 mm to 400 mm (preferably in the range of 200 mm to 300 mm).

It is possible that instructions for the operation are printed onto the motor vehicle seat protective film 1 (additional to any other prints as a customer address or a trademark of the manufacturer).

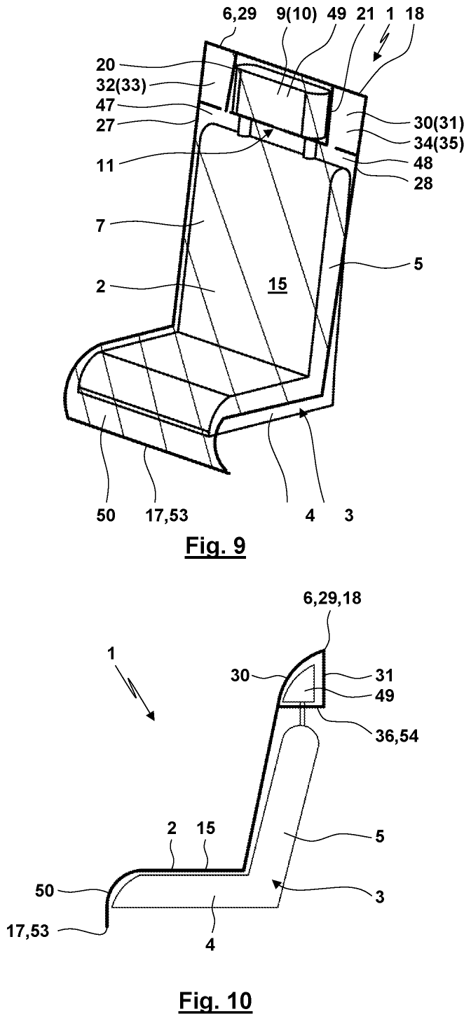

For applying a motor vehicle seat protective film 1 onto a motor vehicle seat 3 as shown in FIGS. 9 and 10 the pocket 11 is imposed on a headrest 49 of the motor vehicle seat 3 which might require an elastic widening of the motor vehicle seat protective film 1. The front sheet covering region 15 is applied to the front side of the backrest 5 and to the upper side of the seat cushion 4 so that the backrest 5 and the seat cushion 4 are completely covered.

In the upper end region the front sheet covering region 15 comprises corner regions 47, 48. If the front sheet side regions 32, 33 and the rear sheet side regions 34, 35 were not present, these corner regions 47, 48 would not have any support additional to the support by the corners of the backrest 5 so that it would be possible that the corner regions 47, 48 easily remove from the corners of the backrest 5 and “fold inwards”. For the shown embodiment the corner regions 47, 48 of the front sheet covering region 15 are connected via the front sheet side regions 32, 33 to the associated welding 20, 21, the front sheet pocket region 9 and via the folding 6 to the rear sheet pocket region 10 and the associated rear sheet side region 34, 35, so that the corner regions 47, 48 can additionally be held in their designated position and orientation.

In FIGS. 9 and 10 it can be seen that the position and orientation of the motor vehicle seat protective film 1 on the motor vehicle seat 3 can be set independent on the extend the headrest 49 has been pulled out of the backrest. Dependent on the extent of the extraction of the headrest 49 out of the backrest the front sheet covering region 15 displaces only to a small extend in longitudinal direction relative to the seat cushion 4 and the backrest 5. Here, the longitudinal extension of the front sheet covering region 15 is chosen such that the seat cushion 4 is also covered in the region where it has to be protected if the headrest 49 extends maximally out of the seat cushion 4. Accordingly, for the non-maximally extended headrest 49 the front sheet covering region 15 extends beyond the portion of the seat cushion 4 which is to be protected and might hang down from the seat cushion 4. The excess portion 50 might e.g. at least have a longitudinal extension which equals the maximum distance the headrest 49 is extracted from the backrest 5.

It is possible that a film web 40 or also single motor vehicle seat protective films 1 is/are folded to a C-shape for a storage, the storage in a cardboard box or for the winding to a coil (additional to the aforementioned foldings). When wound to a coil, the C-shaped folding has the effect that overlaps formed by the ends of the C with the base leg of the C lead to a more dense in the lateral edge region of the coil and so to a more stable wound package than in the middle when seen in lateral direction. By means of a C-shaped folding it is also possible to adapt the dimension such that the dimension (or a multiple of the dimension of a plurality of motor vehicle seat protective films arranged one besides the other) corresponds to the dimension of a standardized euro-pallet.

It is possible that the motor vehicle seat protective film 1 is designated for multiple use. It is possible that the motor vehicle seat protective film 1 can be used for one or a plurality of days or for weeks. It is possible that the motor vehicle seat protective film 1 is completely manufactured from a recycled plastic film, comprises a recycled film section or preferably an inner layer of the film is made of a recycled material or contains recycled material where preferably the mass percentage of the recycled material is in the range of 10% to 70% (in particular 30% to 60%) of the overall mass of the plastic film. If an inner layer or the middle layer of three layers is made of a recycled material, the recycled material might have a percentage up to 50% (percent by weight or volumetric percentage) of the whole material of the layered film. In this case, preferably on the outer side facing towards the user the outer layer has a smaller coefficient of friction than the other outer layer on the outer side facing towards the motor vehicle seat.

As long as the motor vehicle seat protective film 1 is not contaminated it is possible to reuse the motor vehicle seat protective film 1. After its usage it is possible to recycle the motor vehicle seat protective film 1 in its entirety.

Within the frame of the invention it is possible that (differing from the shown embodiments) the front sheet side regions 32, 33 are removed by cutting them away during the production of the motor vehicle seat protective film 1 or it is possible that the front sheet side regions 32, 33 can be separated by perforations. The cut or separated front sheet side regions 32, 33 can then be used for other purposes and can be adapted by additional measures to the other purposes, in particular for the purpose to use them as protective film for another part of the motor vehicle. It is e.g. possible that the front sheet side regions 32, 33 form a pocket-like protective film for a shift lever. Also in a film web 40 as e.g. shown in FIG. 8 the front sheet side regions 32, 33 can be removed. Accordingly, in this case the film web 40 does not have a continuous straight upper edge. Instead, in the region of the upper edge and of the front sheet side regions 32, 33 there are e.g. rectangular cutouts. Here, the two front sheet side regions 32, 33 of adjacent motor vehicle seat protective films 1a, 1b can be removed by a common rectangular cutout or perforation arranged between the weldings 20, 21.

It is generally possible that in the case that a film comprising three layers is used for the motor vehicle seat protective film 1a middle layer is at least partially made of a recycled film. It is e.g. possible that the middle layer is made of the material from the cutout front sheet side regions 32, 33.

It is also possible that the length 25 of the motor vehicle seat protective film 1 is dimensioned such that the motor vehicle seat protective film 1 does not only cover the motor vehicle seat 3 but extends beyond the front edge of the seat cushion 4 so that also the front side of the motor vehicle seat 3 is covered by the down-hanging section of the motor vehicle seat protective film 1. Alternatively or accumulatively it is even possible that the footwell floor in front of the motor vehicle seat 3 is covered so that the motor vehicle seat protective film 1 is arranged between the footwell floor and the shoes of the person sitting on the motor vehicle seat 3 and the motor vehicle seat protective film 1 fulfils an additional protective function.

The motor vehicle seat protective film 1 consists of a plastic film 2 with weldings 20, 21 and the folding 6. The plastic film 2 is rectangular and comprises an upper film edge 54 (forming the edge 36 of the pocket 11), a lower film edge 53 (forming the lower edge 17 of the motor vehicle seat protective film 1), a left lateral film edge 55 (forming the left lateral edge 27 of the motor vehicle seat protective film 1), a right lateral film edge 56 (forming the right lateral edge 28 of the motor vehicle seat protective film 1), a film length L (equaling the length 25 plus the length 24) and a film width W (corresponding to the width 22 of the motor vehicle seat protective film 1).

On both sides the motor vehicle seat protective film 1 forms stairs contours 51, 52 in the upper end region. The stairs contours 51, 52 might have at least two steps each. Preferably, the stairs contours 51, 52 are mirror images of each other when mirrored by a mirror extending along the longitudinal axis of the motor vehicle seat protective film 1. The stair 51 (respectively 52) is formed by the lateral edge 27 (respectively the lateral edge 28), the edge 36 of the pocket 11, the welding 20 (respectively 21) and the upper edge 18.

In the patent claims the width 22 of the plastic film 2 is also denoted with the letter “W” whereas the length of the plastic film 2 in the unfolded state is denoted with the letter “L”.

The motor vehicle seat protective film 1 is in particular made of a rectangular plastic film 2 having a length L and a width W.

It is possible that the plastic film 2 is made of two or more film sections having the same or differing materials and/or the same or differing numbers of layers and/or the same or differing layer compositions. In this case the film sections are adhered to each other, welded to each other or connected in another way to each other by a material bond for establishing an integral plastic film 2. However, preferably the plastic film 2 (and so the motor vehicle seat protective film 1) is made and consist of one single one-pieced film.

I claim:

1. A motor vehicle seat protective film
a) made of a plastic film comprising an upper film edge, a lower film edge, a left lateral film edge, a right lateral film edge, a film length L and a film width W and comprising a folding such that the plastic film forms a front sheet and a rear sheet,
b) the front sheet having a front sheet length being larger than the film length L minus 40 cm,
c) the rear sheet having a rear sheet length being smaller than 40 cm,
d) the front sheet consisting of a front sheet covering region and a front sheet upper end region, the front sheet upper end region having a front sheet upper end region length being smaller than 40 cm,
e) the rear sheet consisting of a rear sheet upper end region having a rear sheet upper end region length being smaller than 40 cm,
f) the front sheet upper end region and the rear sheet upper end region being directly welded to each other by weldings, the weldings having a lateral welding distance being smaller than 90% of the film width W,
g) the front sheet upper end region, the rear sheet upper end region, the weldings and the folding forming a pocket designed and configured for being imposed on a headrest of the motor vehicle seat.

2. The motor vehicle seat protective film of claim 1 wherein
a) the left lateral film edge, the upper film edge or an upper edge of the front sheet covering region, a first one of the weldings and the folding form a first stairs contour and
b) the right lateral film edge, the upper film edge or another upper edge of the front sheet covering region, a second one of the weldings and the folding form a second stairs contour.

3. The motor vehicle seat protective film of claim 2 wherein the first stairs contour and the second stairs contour being mirror images of each other.

4. The motor vehicle seat protective film of claim 1 wherein
a) in the front sheet upper end region the weldings separate a front sheet pocket region from front sheet lateral regions, the front sheet lateral regions being arranged laterally from the front sheet pocket region and
b) in the rear sheet upper end region the weldings separate a rear sheet pocket region from rear sheet lateral regions, the rear sheet lateral regions being arranged laterally from the rear sheet pocket region.

5. The motor vehicle seat protective film of claim 4 wherein the front sheet covering region comprises corner regions in the upper end region which are connected by the front sheet lateral regions to at least one of
a) one of the weldings,
b) the front sheet pocket region and
c) the rear sheet pocket region or the rear sheet lateral region.

6. The motor vehicle seat protective film of claim 1, wherein the plastic film has a thickness being smaller than 100 μm.

7. The motor vehicle seat protective film of claim 6, wherein the plastic film comprises at least two layers.

8. The motor vehicle seat protective film of claim 7, wherein a first outer layer of the plastic film has a smaller friction or adhering effect than a second outer layer of the plastic film.

9. The motor vehicle seat protective film of claim 8, wherein the first outer layer comprises HDPE and the second outer layer comprises LLDPE.

10. The motor vehicle seat protective film of claim 8, wherein the second outer layer comprises chalk with a percentage by weight of 3 to 20%.

11. The motor vehicle seat protective film of claim 1, wherein the plastic film is manufactured with a direction of extrusion having an orientation transverse to a longitudinal extension of the motor vehicle seat protective film.

12. The motor vehicle seat protective film of claim 1 wherein another folding is provided in the front sheet covering region.

13. The motor vehicle seat protective film of claim 12, wherein
a) the motor vehicle seat protective film is made of a tube section,
b) the tube section comprises flattenings forming the folding and the additional folding,
c) the tube section comprises a slit separating the lower film edge of the plastic film from the upper film edge of the plastic film and
d) tube section ends of the tube section form the lateral film edges of the plastic film.

14. The motor vehicle seat protective film of claim 1, wherein the depth of the pocket is smaller than 300 mm.

15. The motor vehicle seat protective film of claim 1, wherein
a) the film length L is less than 25% larger than the length of the motor vehicle seat protective film with the folding and the weldings and
b) the film width W equals the width of the motor vehicle seat protective film with the folding and the weldings.

16. The motor vehicle seat protective film of claim 1, wherein the film width W of the plastic film is smaller than 900 mm.

17. A film web comprising a plurality of motor vehicle seat protective films of claim 1.

18. A method for producing a film web of claim 17 comprising the following method steps:
a) production of a tube section comprising flattenings that form the folding and an additional folding,
b) production of a slit of the tube section, the slit separating the lower film edge from the upper film edge,
c) production of the weldings and
d) production of perforations or cuts forming the lateral film edges.

19. Motor vehicle seat assembly comprising a motor vehicle seat protective film of claim 1 and a motor vehicle seat with a headrest, a seat cushion and a backrest,
a) the pocket of the motor vehicle seat protective film being imposed on the headrest of the motor vehicle seat,
b) the front sheet covering region of the motor vehicle seat protective film loosely lying on the motor vehicle seat and covering the seat cushion and the backrest of the motor vehicle seat and
c) the motor vehicle seat protective film only being secured against slippage by
the accommodation of the headrest of the motor vehicle seat in the pocket of the motor vehicle seat protective film and
the friction of the front sheet covering region with the seat cushion and the backrest of the motor vehicle seat and an adhering effect of the front sheet covering region to the seat cushion and to the backrest of the motor vehicle seat.
